(19) United States
(12) Patent Application Publication
(10) Pub. No.: US 2007/0198644 A1
(43) Pub. Date: Aug. 23, 2007

(54) Process for 2-way email

(75) Inventor: Hee Young Noh, San Francisco, CA (US)

Correspondence Address: HEE YOUNG NOH, 2431-24TH AVE, SAN FRANCISCO, CA, 94116, US

(73) Assignee: Bok Soon Noh, Pusan (KR)

(21) Appl. No.: 11/699,084

(22) Filed: Jan. 29, 2007

Related U.S. Application Data
(60) Provisional application No. 60/774,873, filed on Feb. 18, 2006.

(51) Int. Cl. G06F 15/16

(52) U.S. Cl. 709/206

(57) ABSTRACT

email stamp is a process wherein one has to buy email-stamp via his credit card, so that this proces will eliminate robot-generating spam and also it will identify who pays for email-stamp, wherein each member will be identified each time he/she gets to use “get paid per email” 2way email-stamp.

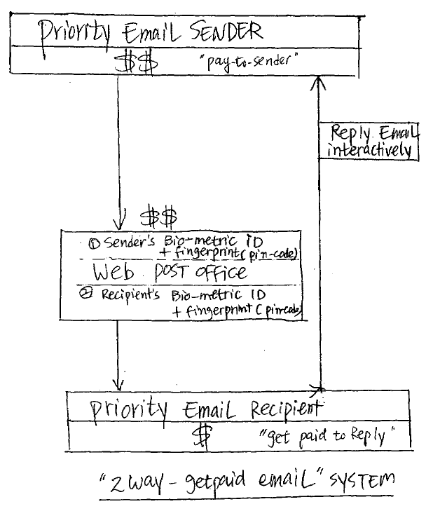

and in order to streamline on current technology, the web post office will send daily or periodic “get paid per email-Advertisment or email-survey” to credit toward a cell phone service, and this progressive profile will generate new era of web statistic method.

### CROSS REFERENCE TO RELATED APPLICATIONS

This application is based on provisional application serial number oc000000018405313, filed on Feb. 18, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of EMAIL and more specifically to a process for 2-way email.

this process is created to cure current email system,and use email as one's permanent contact info, and make available into tatooable email ID, or email wrist band, email microchip

current email address changes, spams, domino-harassment email etc

current animal microchip ID is applied to this invention, by eliminating SPAM,

current email address is not voice-recognizable, but this process will allow one's phone number as his/her's email address.

current email address also provides to file a complaint, by pay2 blog, so that free blogging system wont be abused without meritous complaint.

Pay2blog will allow my system to hire an expertise mediator in its complaining issues.

current email address will search old/expired once-individualized data on one's history. no bounced email, it will remove virus as well.

Environmentally greener email

homeland security accessory measure, if one agrees to go thru more detailed criminal record/credit report attached to his profile at www.permaID.com

### BRIEF SUMMARY OF THE INVENTION

The primary object of the invention is this process does not produce any spam, ignored-email,virus on emails.

Another object of the invention is this process creates E-consultation concept on web (not E-commerce).

Another object of the invention is this process will allow to create numeric email address which subsequently convert into numeric email ID bar code which can be scannable.

A further object of the invention is this process will allow to send an email to expired or old email addresses, or current email address by utilizing old or expired personal information.

Yet another object of the invention is this process will allow to send an email instantly to someone (Ez-connect) who has visible individualized data, such as auto license number, phone number or residential address.

Still yet another object of the invention is or social security number, driver's license #, bank account #, credit card #(any once-individualized information can be searched by this inventional email registry system.

Another object of the invention is this process will create “get paid per email” wherein any computer user can find his/her information from human intelligence (E-consult).

Another object of the invention is this process will allow law enforcing agency or emergency medical team to identify one's email contact and emergency contact and medical/criminal history.

A further object of the invention is this process will allow an email-on-demand, by specifically request on reply-content by paying for it.

Yet another object of the invention is this proces will allow fund-raising charity organization to collect fund via email and get to collect email list, and reply with how fund was spent.

This email stamp for 2way priority email system will be used for E-CONSULT, E-CONNECT, E-IDENTIFICATION, E-DEBIT CARD ID.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for 2-way email comprising the steps of: and email stamp for priority email service. email stamp will provide all usps postal service, without spam,and get paid to reply

this process will create WEB POST OFFICE WHEREIN EACH MEMBER GETS WEB PO BOX, AS PROXY EMAIL ADDRESS, WITHOUT SPAM.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGURE GET PAID PER EMAIL is a perspective view of the invention.

1. REGISTER WWW.PERMAID.COM, AND FILL OUT HIS/HER MEMBER'S PROFILE

2. ACCEPT DAILY OR PERIODIC “GET PAID PER EMAIL” (ADVERTISEMENT, OR SURVEY), TO UPDATE HIS PROFILE (“PROGRESSIVE PROFILE)

THIS WILL KEEP DAILY CELL PHONE SERVICE FOR LIMITED TIME, such as 911, receiving message only etc

3. ATTACH HIS/HER EMAIL ADDRESS TO HIS BELONGINGS, OR GIVE OUT

4. ONCE A PRIORITY EMAIL IS RECEIVED, HE/SHE SHALL REPLY, AND COLLECT THE MONEY

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

THIS INVENTION WILL CURE CURRENT EMAIL PROBLEM AND ALSO ALLOWS EMAIL ADDRESS AS ONE'S IDENTIFICATION, BY CREATING EMAIL TAG (FOR ONE'S BELONGINGS) AND EMAIL-MICROCHIP FOR MEDICAL/CRIMINAL HISTORY. (permaID.com registry)

THIS INVENTION WILL CURE CURRENT EMAIL PROBLEM AND PROVIDES EMAIL-MICROCHIP/EMAIL-TAG, TO FORTIFY ONLINE-SECURITY, AND AT AIRPORT, ALONG WITH RETINA EXAM/FINGER PRINT, IT CAN BE UTILIZED AS “HOMELAND SECURITY”, AND THIS EMAIL REGISTRY SYSTEM (AS CONVENTIONAL YELLOW PAGES/WHITES PAGES) DOESNT PRODUCE ANY PHYSICAL PAPER TO BE TRASHED EVERY YEAR.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for 2-way email comprising the steps of:
email stamp for priority email service.
email stamp will provide all usps postal service, without spam, and get paid to reply
